(19) United States
(12) Patent Application Publication
(10) Pub. No.: US 2006/0209263 A1
(43) Pub. Date: Sep. 21, 2006

(54) OFF-AXIS OPTICAL ENGINE IN AN LCOS PROJECTION SYSTEM

(76) Inventors: Anthony Joseph Whitehead Jr., Hsin-Chu City (TW); Ta-Shuang Kuan, Hsin-Chu Hsien (TW); Chia-Tsung Chan, Tao-Yuan Hsien (TW); Yi-Ming Chang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/907,029

(22) Filed: Mar. 17, 2005

(51) Int. Cl. G03B 21/14

(52) U.S. Cl. 353/31

(57) ABSTRACT

An off-axis optical engine in an LCoS projection system has an LCoS panel, and the LCoS panel has a liquid crystal layer with a longitudinal axis of liquid crystal molecules parallel to an incident direction of a first light beam directed to the LCoS panel. The liquid crystal molecules in the liquid crystal layer are vertically aligned and pretilted by an angle of about 0-20 degrees.

### BACKGROUND OF INVENTION

1. Field of the Invention

The present invention relates to an off-axis optical engine in an LCoS projection system, and more particularly, to an off-axis optical engine in a vertically aligned nematic (VAN) LCoS projection system.

2. Description of the Prior Art

Liquid-crystal-on-silicon (LCoS) projection systems work on similar principles to LCD projection systems. A significant difference between an LCoS projection system and an LCD projection system is the way to modulate light within the projection system. The LCD projection system has transmissive architecture, and light emitted from a light source has to pass liquid crystal so as to be modulated. The LCoS projection system has reflective architecture and uses at least one LCoS panel, which is composed of a glass substrate, liquid crystal, and a CMOS chip with electricity circuits and a reflective layer coated thereon, to modulate optical signals produced by a light source and reflect the modulated signals to a projection screen.

An optical engine in the LCoS projection system can be classified to single-panel architecture or three-panel architecture according to the number of LCoS panels to be used. The three-panel optical engine divides an light beam emitted from a light source into R, G, B primary beams and transmits the R, G, B primary beams to three LCoS panels, respectively. The monochromatic images reflected from the three LCoS panels then pass a combination system to compose a colorful image to be projected onto a projection screen. The single-panel optical engine uses a single LCoS panel and the properties of temporal integration and spatial integration by eyes to combine the monochromatic images of R, G, B beams to form a colorful image. Since the single-panel optical engine has the advantages of occupying less space, using single LCoS panel, and having simpler beam-splitting and beam-combination systems, it has the superiority in the manufacturing costs while competing with the three-panel optical engine. Being similar to the design of most three-panel optical engines, the single-panel optical engine usually uses a polarization beam splitter (PBS) to separate the incident light and the reflective light of the LCoS panel.

Referring to FIG. 1, FIG. 1 is a schematic diagram of a single-panel on-axis optical engine according to the prior art. As shown in FIG. 1, an on-axis optical engine 10 includes a light source 12 for generating an incident light beam b₁, a light pipe 14 for collecting the incident light beam b₁ and reducing the directionalities of the incident beam b₁, and a color wheel 16 for splitting the incident light beam b₁ into monochromatic beams such as a red light beam, a blue light beam, and a green light beam in sequence. The on-axis optical engine 10 further includes a polarizer 18 for polarizing the incident light beam b₁ by a specific polarization direction. For example, the incident light beam b₁ can be an S-polarized light beam after passing the polarizer 18. A PBS 20 is used to direct the polarized incident light beam b₁ to an LCoS panel 22. When the LCoS panel 22 is at an “on” state, the incident S-polarized light beam can be converted to a P-polarized light beam and reflected from the LCoS panel 22. After the reflective light beam b₂ leaves the LCoS panel 22, the PBS 20 passes the P-polarized reflective light beam to an analyzer 24. The analyzer 24 passes the light beam with a specific polarization direction, such as the P-polarized light beam, to a projection lens. The S-polarized reflective light beam leaving the LCoS panel 22, however, is reflected by the PBS 20 to the light source 12.

The on-axis optical engine mentioned above is a sequential color type optical engine, which is characterized by using rotating R, G, B color rings in the color wheel 16 to split the white light beam into a sequence of the R, G, B primary beams. The three primary color images are displayed in sequence at a rate that is three times a frame rate or higher so that all three primary color images are displayed over the course of one display frame. The eyes integrate the sub-frames temporally, yielding a perceived full-color image.

In addition, a conventional spatial color type optical engine is often used, which is characterized by dividing one pixel of the display into three sub-pixels, with one sub-pixel dedicated to each primary color. The transmission or reflective level of each primary image can be locally controlled. When the sub-pixels are sufficiently small, they are not individually resolvable by the viewer. Referring to FIG. 2, FIG. 2 is a schematic diagram of a spatial color type on-axis optical engine according to the prior art. As shown in FIG. 2, an on-axis optical engine 30 includes a light source 32 for generating an incident light beam b₁, and a polarizer 34 for polarizing the incident light beam b₁ by a specific polarization direction. For example, the incident light beam b₁ can be an S-polarized light beam after passing the polarizer 34. A PBS 36 is used to direct the polarized incident light beam b1 to an LCoS panel 38. When the LCoS panel 38 is at an “on” state, the incident S-polarized light beam can be converted to a P-polarized light beam and reflected from the LCoS panel 38. After the reflective light beam b₂ leaves the LCoS panel 38, the PBS 36 passes the P-polarized reflective light beam to an analyzer 40. The analyzer 40 passes the light beam with a specific polarization direction, such as the P-polarized light beam, to a projection lens. The S-polarized reflective light beam leaving the LCoS panel 38, however, is reflected by the PBS 36 to the light source 32.

The spatial color type on-axis optical engine 30 is distinguished from the sequential color type on-axis optical engine 10 by using a color filter array to spatially control the images displayed on the sub-pixels while the sequential color type on-axis optical engine 10 uses the color wheel to temporally control the images displayed on the pixels. In spite of having this difference, the PBS is inevitable in both of the sequential color type on-axis optical engine 10 and the spatial color type on-axis optical engine 30 to separate the incident and reflective light beams. Since the PBS is extremely expensive and a brightness or contrast loss is caused while the light passing the PBS, applications of the on-axis optical engines are limited.

### SUMMARY OF INVENTION

It is therefore an object of the present invention to provide an off-axis optical engine for an LCoS projection system to reduce the cost and improve the optical performance of the optical engine.

According to one embodiment of the present invention, the off-axis optical engine has an LCoS panel, and the LCoS panel has a liquid crystal layer with a longitudinal axis of liquid crystal molecules parallel to an incident direction of a first light beam directed to the LCoS panel. The liquid crystal molecules in the liquid crystal layer are vertically aligned and pretilted by an angle of about 0-20 degrees.

The present invention adjusts the optical axis incident on the LCoS panel to parallel to the longitudinal axis of the liquid crystal molecules. In addition, the off-axis optical engine provides a reflective light beam having an optical path separated from the light beam incident on the LCoS panel, so that the reflective light beam can be directed to a projection lens without a PBS. The present invention provides the advantages of reducing the cost and preventing the contrast ratio limit of the PBS since there is no PBS in the optical engine, and a high contrast performance similar to an on-axis optical engine can also be achieved by the present invention.

These and other objects of the claimed invention will be apparent to those of ordinary skill in the art with reference to the following detailed description of the preferred embodiments illustrated in the various drawings.

### BRIEF DESCRIPTION OF DRAWINGS

FIG. 1 is a schematic diagram of an on-axis optical engine according to the prior art;

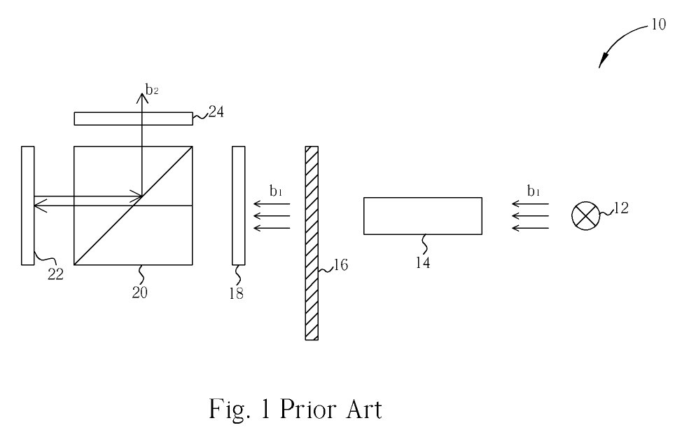

FIG. 2 is a schematic diagram of another on-axis optical engine according to the prior art;

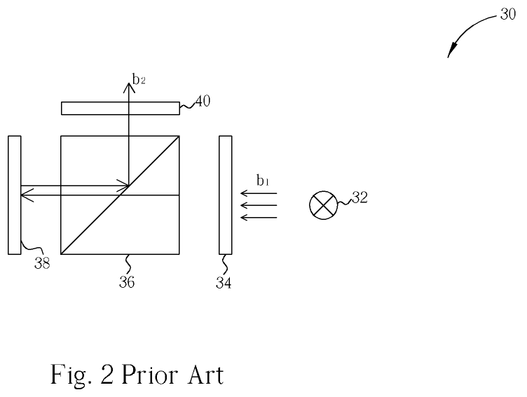

FIG. 3 is a schematic diagram of an off-axis optical engine according to the present invention;

FIG. 4 illustrates the relationship between an optical axis of an incident light on an LCoS panel and a longitudinal axis of liquid crystal molecules in the LCoS panel according to the present invention; and

FIG. 5 is a schematic diagram of another off-axis optical engine according to the present invention.

### DETAILED DESCRIPTION

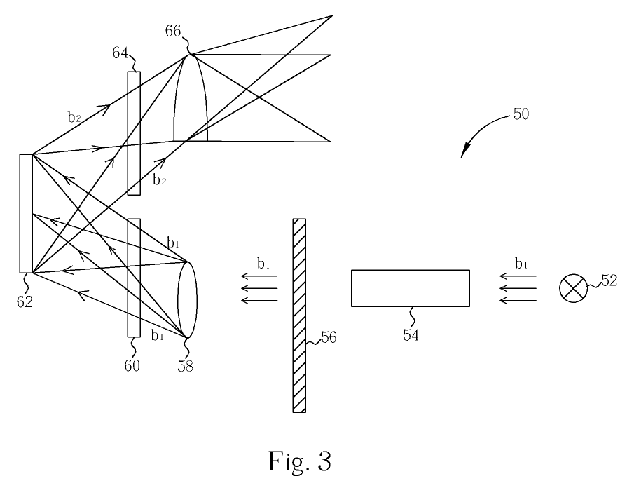

Referring to FIG. 3, FIG. 3 is a schematic diagram of a sequential color type off-axis optical engine according to the present invention. As shown in FIG. 3, an off-axis 50 includes a light source 52 for generating an incident light beam b1, a light pipe 54 for collecting the incident light beam b₁ and reducing the directionalities of the incident light beam b₁, and a color wheel 56 for splitting the incident light beam b₁ into monochromatic beams such as a red light beam, a blue light beam, and a green light beam in sequence. The off-axis optical engine 50 further includes a condenser system 58 for passing the split incident light beam b₁ to a polarizer 60 and thereafter to an LCoS panel 62. The LCoS panel 62 is a reflective panel, and a reflective light beam b₂ from the LCoS 62 is transmitted to an analyzer 64 and a projection lens 66 so as to be projected to a screen.

In this embodiment, the incident light beam b₁ passes rotating R, G, B color rings in the color wheel 56 to produce a sequence of the R, G, B primary beams. The monochromatic beam then passes the condenser system 58, which can be composed of a single or a plurality of lenses, to adjust the angle of the incident optical axis to enter the LCoS panel 62. The polarizer 60 provides a specific polarization direction for polarizing the incident light beam b₁. The analyzer 64 provides a specific polarization direction to pass the reflective light beam b₂ with a specific polarization direction. According to the conversion requirement of the polarization directions of the light beams b₁ and b₂ (whether the polarization direction of the reflective light beam b2 has to be converted), the polarization direction of the analyzer 64 can be either parallel to or perpendicular to the polarization direction of the polarizer 60.

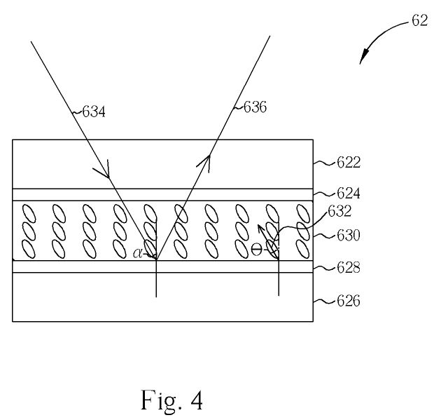

Referring to FIG. 4, FIG. 4 illustrates the relationship between an optical axis of an incident light on an LCoS panel and a longitudinal axis of liquid crystal molecules in the LCoS panel according to the present invention. As shown in FIG. 4, the LCoS panel 62 includes two parallel substrates 622 and 626, an alignment film 624 affixed on a surface of the substrate 622 to face the substrate 626, an alignment film 628 affixed on a surface of the substrate 626 to face the substrate 622, and a liquid crystal layer 630 filling within the gap between the substrate 622 and the substrate 626. The substrate 622 is a transparent substrate, such as a glass substrate, and is previous to light. The substrate 626 is a semiconductor substrate having CMOS driving circuits and a reflective layer coated thereon. In a preferred embodiment of the present invention, liquid crystal molecules in the liquid crystal layer 630 are vertically aligned, so that a longitudinal axis 632 of the liquid crystal molecules is perpendicular to the alignment films 624 and 628. In order to obtain uniform distribution, the liquid crystal molecules are pretilted by a specific angle from the alignment films 624 and 628. For example, a pretilt angle θ between the longitudinal axis 632 of the liquid crystal molecules and a normal direction on the alignment film 628 is suggested to between 0 and 20 degrees, and 3 degrees is preferred. The incident light beam follows a direction 634 to enter the LCoS panel 62 and then follows a direction 636 to leave the LCoS panel 62. In order to increase the brightness of the reflective light beam, the direction 634 of the incident light beam should be optimized with the optical characteristics of the LCoS projection system, such as the cell gap, the pretilt angle θ, and the alignment directions provided by the alignment films 624 and 628. In a preferred embodiment of the present invention, the direction 634 of the incident light beam must be approximately parallel to the longitudinal axis 632 of the liquid crystal molecules, so that an incident angle α between the direction 634 of the incident light beam and a normal direction on the alignment film 628 is approximately equal to the pretilt angle θ of the liquid crystal molecules. A difference between the incident angle α and the pretilt angle θ is suggested to being less than 1 degree.

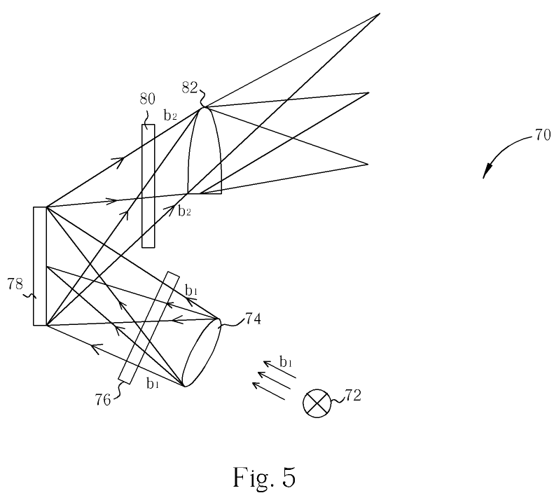

The inventive concept of controlling the incident angle of light to be approximately equal to the pretilt angle of liquid crystal can be further applied in other off-axis optical engine architecture according to other embodiments of the present invention. Please refer to FIG. 5. FIG. 5 is a schematic diagram of another off-axis optical engine according to the present invention. As shown in FIG. 5, a spatial color type off-axis optical engine 70 includes a light source 72 for generating an incident light beam b₁, and a condenser system 74 for passing the incident light beam b₁ to a polarizer 76 and thereafter to an LCoS panel 78. The LCoS panel 78 is a reflective panel, and a reflective light beam b₂ from the LCoS 78 is transmitted to an analyzer 80 and a projection lens 82 so as to be projected to a screen. The polarizer 76 provides a specific polarization direction for polarizing the incident light beam b₁. The analyzer 80 provides a specific polarization direction to pass the reflective light beam b₂ with a specific polarization direction. According to the conversion requirement of the polarization directions of the light beams b₁ and b₂ (whether the polarization direction of the reflective light beam b₂ has to be converted), the polarization direction of the analyzer 80 can be either parallel to or perpendicular to the polarization direction of the polarizer 76. In this embodiment, the incident light beam b₁ enters the LCoS panel 78 following an incident direction, and the incident direction has to be approximately parallel to a longitudinal direction of liquid crystal molecules in the LCoS panel 78, as is illustrated in FIG. 4.

In addition, the present invention does not limit to single-panel optical engine architecture. The inventive concept of controlling the incident angle of light to be approximately equal to the pretilt angle of liquid crystal can be further applied in three-panel off-axis optical engine architecture according to other embodiments of the present invention. For example, an X-prism or a similar beam-splitting system is used in the three-panel optical engine to split the polarized incident light beam into a red light beam, a blue light beam, and a green light beam. The three monochromatic light beams are then transmitted to three corresponding LCoS panels. An incident direction of each of the red, blue, and green light beams to enter the corresponding LCoS panel has to be approximately parallel to a longitudinal axis of liquid crystal molecules in the LCoS panel, as is illustrated in FIG. 4. The monochromatic images reflected from the three LCoS panels then pass the X-prism or a similar beam-combination system to compose a colorful image to be projected onto the projection screen.

In contrast to the prior art, the off-axis optical engine of the present invention adjusts the optical axis incident on the LCoS panel to parallel to the longitudinal axis of the liquid crystal molecules, and no PBS is used in the off-axis optical engine. As a result, the advantages of reducing the cost, preventing the contrast ratio limit of the PBS, and providing a high contrast performance similar to an on-axis optical engine can be achieved by the present invention.

Those skilled in the art will readily observe that numerous modifications and alterations of the device may be made while utilizing the teachings of the invention.

What is claimed is:

1. An off-axis optical engine in an LCoS projection system, the off-axis optical engine comprising;
at least one LCoS panel, the LCoS panel comprising a liquid crystal layer;
a light source for generating a first light beam; and
a condenser system for condensing the first light beam to enter the LCoS panel, the first light beam forming an incident angle on a surface of the LCoS panel, a difference between the incident angle of the first light beam and a pretilt angle of liquid crystal molecules in the liquid crystal layer being less than 1 degree.

2. The off-axis optical engine of claim 1, wherein the LCoS panel is a reflective panel, and the first light beam is reflected by the LCoS panel to form a second light beam.

3. The off-axis optical engine of claim 1, further comprising a polarizer positioned between the condenser system and the LCoS panel, the polarizer providing a first polarization direction.

4. The off-axis optical engine of claim 3, further comprising an analyzer positioned between the LCoS panel and a projection lens, the analyzer providing a second polarization direction.

5. The off-axis optical engine of claim 4, wherein the first polarization direction is parallel to the second polarization direction.

6. The off-axis optical engine of claim 4, wherein the first polarization direction is perpendicular to the second polarization direction.

7. The off-axis optical engine of claim 1, further comprising a light pipe and a color wheel positioned between the light source and the condenser system, the first light beam passing the light pipe and the color wheel to produce a sequence of red light beams, blue light beams, and green light beams.

8. The off-axis optical engine of claim 1, wherein the liquid crystal molecules in the liquid crystal layer are vertically aligned.

9. The off-axis optical engine of claim 1, wherein the pretilt angle of the liquid crystal molecules is between 0 and 20 degrees.

10. An off-axis optical engine in an LCoS projection system, the off-axis optical engine comprising an LCoS panel, the LCoS panel comprising a liquid crystal layer with a longitudinal axis of liquid crystal molecules parallel to an incident direction of a first light beam directed to the LCoS panel.

11. The off-axis optical engine of claim 10, wherein the LCoS panel is a reflective panel, and the first light beam is reflected by the LCoS panel to form a second light beam.

12. The off-axis optical engine of claim 10, further comprising:
a light source for generating the first light beam;
a condenser system for adjusting the incident direction of the first light beam to enter the LCoS panel;
a polarizer positioned between the condenser system and the LCoS panel, the polarizer providing a first polarization direction; and
an analyzer positioned between the LCoS panel and a projection lens, the analyzer providing a second polarization direction.

13. The off-axis optical engine of claim 12, wherein the first polarization direction is parallel to the second polarization direction.

14. The off-axis optical engine of claim 12, wherein the first polarization direction is perpendicular to the second polarization direction.

15. The off-axis optical engine of claim 10, wherein the first light beam comprises a sequence of red light beams, blue light beams, and green light beams.

16. The off-axis optical engine of claim 10, wherein the first light beam comprises a red light beam, a blue light beam, or a green light beam.

17. The off-axis optical engine of claim 10, wherein the liquid crystal molecules in the liquid crystal layer are vertically aligned.

18. The off-axis optical engine of claim 10, wherein a pretilt angle of the liquid crystal molecules is between 0 and 20 degrees.
